(19) United States
(12) Patent Application Publication
(10) Pub. No.: US 2017/0249131 A1
(43) Pub. Date: Aug. 31, 2017

(54) COMPILATION APPARATUS AND COMPILING METHOD

(71) Applicant: FUJITSU LIMITED, Kawasaki-shi (JP)

(72) Inventor: Yuki KAWAGUCHI, Numazu (JP)

(73) Assignee: FUJITSU LIMITED, Kawasaki-shi (JP)

(21) Appl. No.: 15/412,709

(22) Filed: Jan. 23, 2017

(30) Foreign Application Priority Data
Feb. 26, 2016 (JP) 2016-036090

(51) Int. Cl. G06F 9/45

(52) U.S. Cl. CPC G06F 8/427

(57) ABSTRACT

A compilation apparatus includes a memory; and a processor coupled to the memory and the processor configured to: add a syntax tree for indicating a first function that declares a reference to data of a parse tree created based on a source code when compiling the source code, the reference being a function for a right-hand-side value reference, and rewrite the data of the parse tree when the first function that declares the reference is not detected and a specific second function different from the first function is detected from data of the parse tree.

### CROSS-REFERENCE TO RELATED APPLICATION

This application is based upon and claims the benefit of priority of the prior Japanese Patent Application No. 2016-036090, filed on Feb. 26, 2016, the entire contents of which are incorporated herein by reference.

### FIELD

The embodiment discussed herein relates to a compilation apparatus and a compiling method.

### BACKGROUND

An object-oriented language is an example of one language used in programming. Recent object-oriented languages permit the defining of a function called a right-hand-side value (hereinafter called “rvalue”) reference in a source code and permit the use of coding that explicitly handles rvalues.

A technique has bene proposed that uses rule information which indicates the rules of an object-oriented program, checks the results of an analysis of an input program, and points out a portion that violates the rules and outputs a corrected example. For example, Japanese Laid-open Patent Publication No. 11-085496 discusses an example of the above technique.

In the case of a source code that does not use an rvalue reference, predetermined regions of the memory are secured each time an object is created. For example, even if the rvalue is a temporary variable, a region of the memory for the temporary variable is secured. Further, because the temporary variable is not used after being referred to, the region of the memory is released.

For example, when a predetermined operation is defined in the source code and the operation is repeated, processing for securing and releasing the region of the memory is carried out frequently for temporary variables. As a result, the execution speed is reduced.

Conversely, when using the function of the rvalue reference, the definition of the function which declares the use of the rvalue reference is desirably written in the source code. As a result, writing the source code is complicated.

### SUMMARY

According to an aspect of the invention, a compilation apparatus includes a memory; and a processor coupled to the memory and the processor configured to: add a syntax tree for indicating a first function that declares a reference to data of a parse tree created based on a source code when compiling the source code, the reference being a function for a right-hand-side value reference, and rewrite the data of the parse tree when the first function that declares the reference is not detected and a specific second function different from the first function is detected from data of the parse tree.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of an example of a compilation apparatus;

FIG. 2 is a (first) diagram of an example of a code;

FIG. 3 is a (second) diagram of an example of the code;

FIG. 4 is a diagram for explaining examples of copy and move;

FIGS. 5A and 5B are (third) diagrams of an example of the code;

FIG. 6 is a (fourth) diagram of an example of the code;

FIG. 7 is a (fifth) diagram of an example of the code;

FIG. 8 is a (sixth) diagram of an example of the code;

FIG. 9 is a table illustrating processing for each function carried out by the compilation apparatus;

FIG. 10 is a (seventh) diagram of an example of the code;

FIG. 11 is a (eighth) diagram of an example of the code;

FIGS. 12A and 12B are (ninth) diagrams of an example of the code;

FIG. 13 is a (first) diagram of an example of a syntax tree;

FIG. 14 is a (second) diagram of an example of the syntax tree;

FIG. 15 is a (first) flow chart describing an example of a flow of processing of the present embodiment;

FIG. 16 is a (second) flow chart describing an example of a flow of processing of the present embodiment;

FIG. 17 is a (third) diagram of an example of the syntax tree;

FIG. 18 is a (tenth) diagram of an example of the code;

FIG. 19 is a (fourth) diagram of an example of the syntax tree;

FIG. 20 is a (third) flow chart describing an example of a flow of processing of the present embodiment;

FIGS. 21A and 21B are (fifth) diagrams of an example of the syntax tree;

FIGS. 22A and 22B are (sixth) diagrams of an example of the syntax tree;

FIG. 23 is a (eleventh) diagram of an example of the code; and

FIG. 24 illustrates an example of a hardware configuration of the compilation apparatus.

### DESCRIPTION OF EMBODIMENTS

### Example of Compilation Apparatus of the Present Embodiment

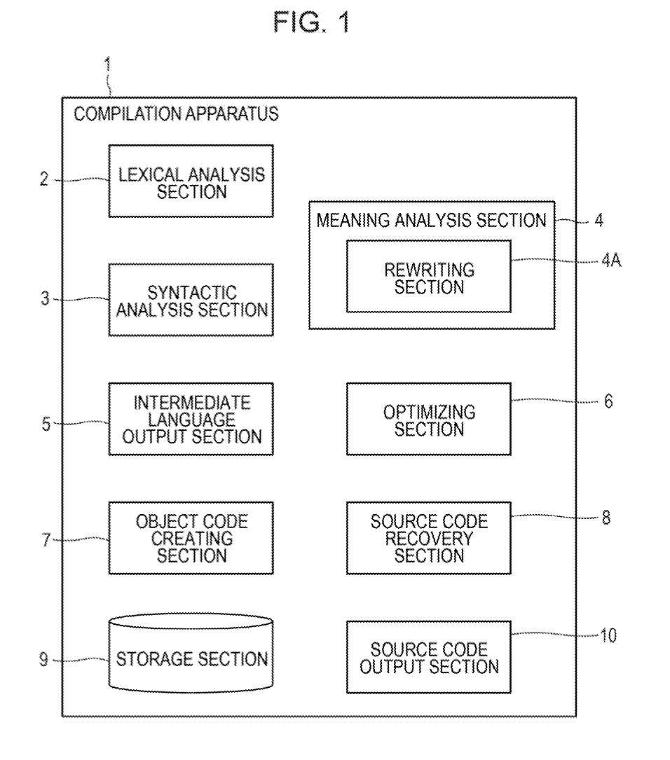

The following is a detailed explanation of an embodiment with reference to the accompanying drawings. FIG. 1 is an example of a compilation apparatus 1. The compilation apparatus 1, for example, is a computing device (computer) for compiling a source code and creating an object code.

The compilation apparatus 1 includes a lexical analysis section 2, a syntactic analysis section 3, a meaning analysis section 4, an intermediate language output section 5, an optimizing section 6, an object code creating section 7, a source code recovery section 8, a storage section 9, and a source code output section 10.

In the present embodiment, the source code is stored in the storage section 9. The lexical analysis section 2 analyzes words and phrases written in the source code obtained from the storage section 9, and, for example, divides the source code into tokens. The source code may also be called a source program.

The syntactic analysis section 3 analyzes the relationships among the words and phrases analyzed by the lexical analysis section 2 and creates data of a syntax tree having a tree structure based on predetermined syntax rules of the analyzed words and phrases. The syntax tree is an example of a parse tree.

The meaning analysis section 4 analyzes the meaning of the syntax tree created by the syntactic analysis section 3. The syntactic analysis section 3 of the embodiment includes a rewriting section 4A. The rewriting section 4A adds a syntax tree indicating a function that declares an rvalue reference to the data of the aforementioned parse tree.

The intermediate language output section 5 outputs intermediate language (intermediate code) based on the data of the syntax tree, the meaning of which has been analyzed by the meaning analysis section 4. The optimizing section 6 optimizes the output intermediate language. The object code creating section 7 creates an object code based on the optimized intermediate language. A central processing unit (CPU) executes the created object code. The object code includes an executable file.

The source code recovery section 8 recovers the source code from the data of the syntax tree rewritten by the rewriting section 4A. The storage section 9 stores various types of information. For example, the storage section 9 stores the source code and the data of the syntax tree and the like. The source code output section 10 outputs the recovered source code.

### Example of rvalues and L-values

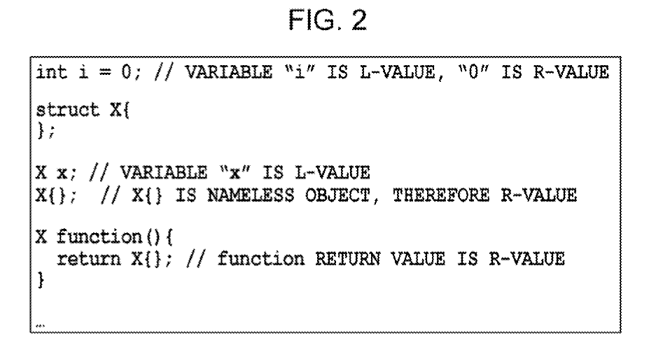

FIG. 2 is an example of a source code written based on the specifications of a predetermined object-oriented language. The examples of source codes in the following figures are similarly based on the specifications of a predetermined object-oriented language.

An actual object and an object having a name attached thereto are called left-hand side values (hereinafter called “L-values”) in the example of the source code in FIG. 2. Conversely, an object that is used temporarily or an object that does not have a name attached thereto is called an rvalue. For example, a variable used temporarily (temporary variable) is an rvalue.

### Examples of Types of Functions

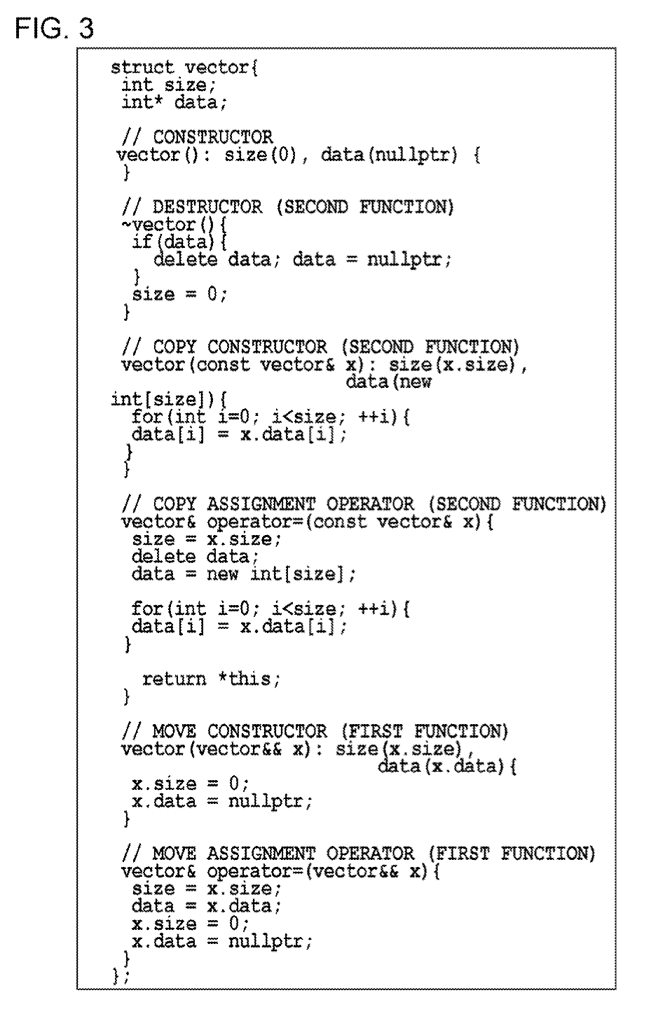

FIG. 3 illustrates examples of six types of functions. A constructor is a function for creating and initializing an object. A destructor is a function for deleting an object. A copy constructor is a function for copying and creating an object of the same class type as itself. A copy assignment operator is a function used in the assignment of an object of a class type.

A move constructor is a function for moving an object of the same class type as itself. A move assignment operator is an assignment operator for making an rvalue reference into a formal parameter. The use of a function of an rvalue reference is declared with the move constructor and the move assignment operator.

In the embodiment, the destructor, the copy constructor, and the copy assignment operator are functions that do not declare rvalue references and are examples of secondary functions. Further, the move constructor and the move assignment operator are functions that declare rvalue references and are examples of primary functions.

The function of the rvalue reference is used by the move constructor and the move assignment operator. The use of the function of the rvalue reference is declared by writing “&&”. In the example in FIG. 3 for example, “vector &&” of the move constructor and the move assignment operator indicates that vector type rvalue references are declared.

Moreover, an “operator” is used for the assignment operator. For example, “operator” is used in the “vector& operator=(const vector& x)” of the copy assignment operator in the example of FIG. 3. Similarly, “operator” is used in the “vector& operator=(vector&& x)” of the move assignment operator.

A temporary variable (rvalue) is a variable that can be discarded in the future. Moreover, a predetermined region of a memory (for example, a random access memory (RAM)) is used for the temporary variable. The memory region used for the temporary variables is re-used for the move constructor and the move assignment operator which declare the rvalue references.

Hereinbelow, the copy constructor and the copy assignment operator are referred to as copy functions, and the move constructor and the move assignment operator are referred to as move functions.

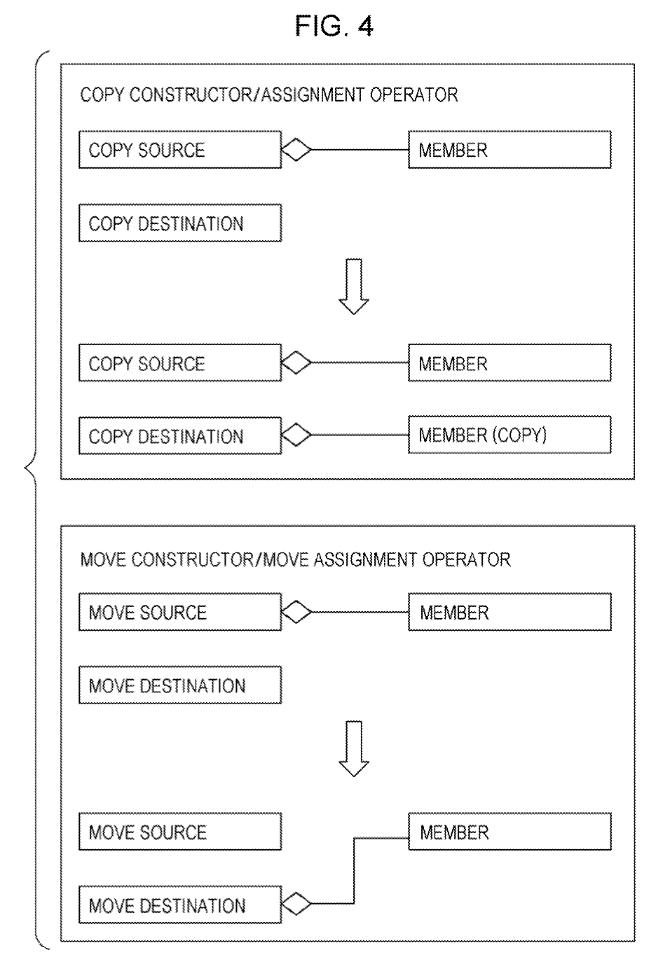

For example, memory regions are used for members and copied members when copying members in the case of the copy function in the example in FIG. 4.

Conversely, in the case of the move function, a memory region is used for one member because the ownership of an object is simply moved to a new member when moving the member. As a result, the utilization amount of the memory is reduced.

In the present embodiment, while the move constructor and the move assignment operator have been explained as functions that declare rvalue references, the rvalue references may also be used in parameters of functions or in assignment operators.

<Example of sample code for summation operation>

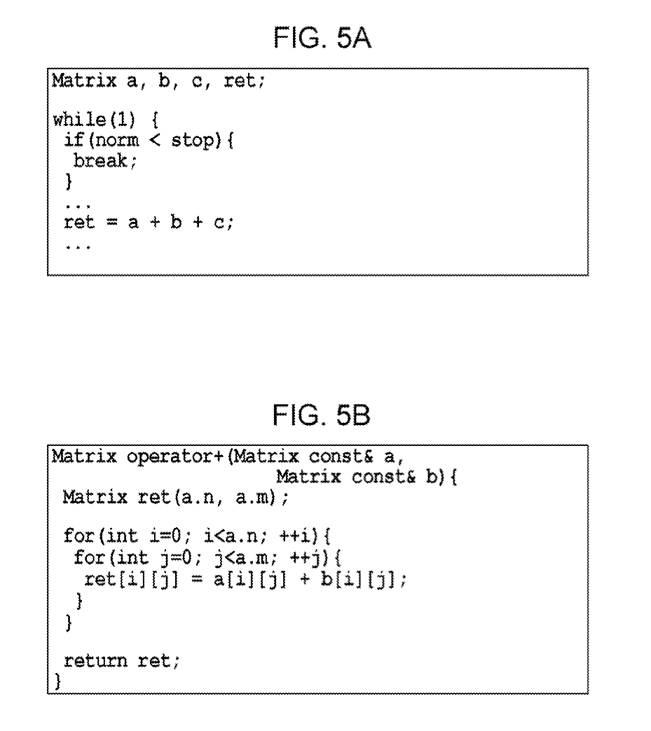

FIG. 5A is an example of a sample code for a summation operation. “a”, “b”, “c”, and “ret” are defined as two-dimensional arrays (matrices) in the sample code in the example in FIG. 5A. The summation operation “ret=a+b+c” is repeated until the condition “norm<stop” is met in the sample code.

The use of an assignment operator is realized in the example of the “sample code” in FIG. 5B. The example of the “code using assignment operator” in FIG. 5B is a code that uses an assignment operator (operator). A summation operation of a two-dimensional array is repeated as illustrated in the example of the “code using assignment operator” in FIG. 5B.

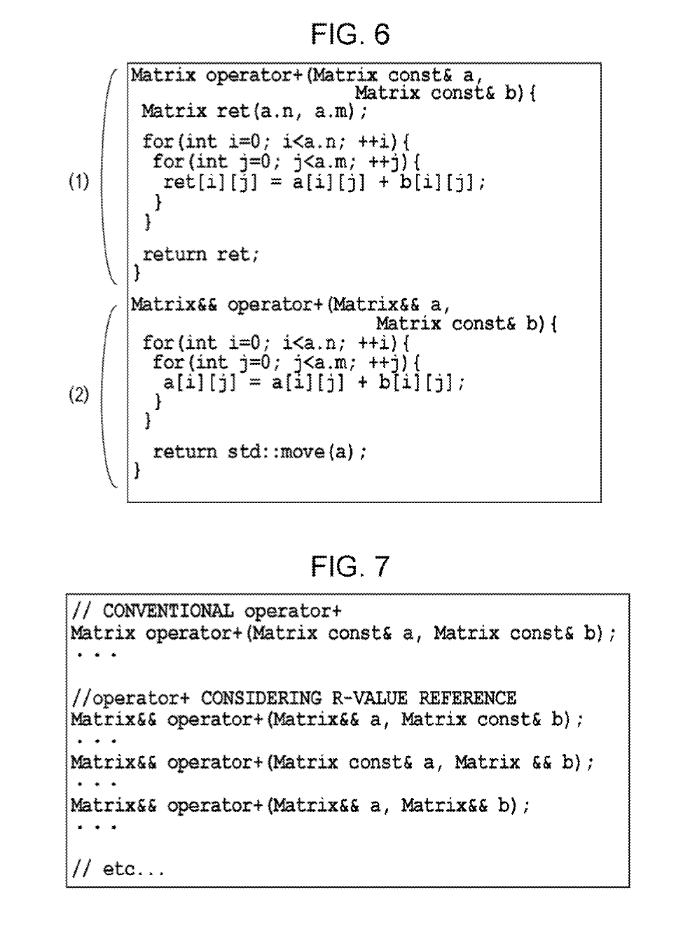

FIG. 6 illustrates an example of a sample code to which an “operator” that declares the use of an rvalue reference is added. The portion (1) of the sample code in the example of FIG. 6 is the same as the “code using assignment operator” in the example in FIG. 5B. The portion (2) is added to the sample code that uses the rvalue reference. “Matrix&&” in the source code of the example in FIG. 6 indicates that the use of the rvalue reference is declared.

When an rvalue reference is not used, only the portion (1) may be written in the sample code of the example in FIG. 6. In this case, the summation operation of the array “a+b” is carried out and the operation result is stored in a temporary variable (designated as “tmp”). A region of the memory is secured for the temporary variable.

Next, the summation operation of the array “tmp+c” is carried out. The operation result of “ret=a+b+c” is obtained as a result. Therefore, when the summation operation “ret=a+b+c” is carried out once, the memory region for the temporary variable “tmp” is secured and the memory region for the operation result “ret” is secured for a total of two memory regions being secured.

The summation operation “ret=a+b+c” is repeated. As a result, the memory region secured for the temporary variable “tmp” is released and the memory region secured for the operation result “ret” so that the memory region is released for a total of two times each time the summation operation is repeated.

Therefore, when an rvalue reference is not used, the securing of the memory is carried out twice and the releasing of the memory is carried out twice when the sample code (1) in FIG. 6 is executed.

As explained above, the portion (2) of the sample code in FIG. 6 is an assignment operator which uses an rvalue reference. In this case, the summation operation of the array “a+b” is carried out and the operation result is returned as the temporary variable “tmp” in the portion (1) of the sample code in FIG. 6.

Because “tmp” is a temporary variable, the summation operation “tmp+c” is carried out by the “operator” defined in the portion (2) of the sample code in FIG. 6. Because the “operator” in the portion (2) is an assignment operator that uses an rvalue reference, only the ownership of the temporary variable is moved and the securing of a memory region is not carried out. Accordingly, the releasing of the memory region is not carried out.

Therefore, the securing of a memory region is carried out once and the releasing of the memory region is not carried out for each time the summation operation “ret=a+b+c” is carried due to the writing of the portion (1) and the portion (2) in the sample code in the example of FIG. 6.

As explained above, the securing of a memory region is carried out twice and the releasing of the memory region is carried out twice for each summation operation of “ret=a+b+c” when the rvalue reference is not used in the source code. Conversely, the securing of a memory region is only carried out once for each summation operation of “ret=a+b+c” when the rvalue reference is used in the source code.

The securing of a memory region and the releasing of a secured memory region takes a predetermined amount of time. Therefore, the execution time is shortened because the securing of a memory region and the releasing of a memory region is reduced when using the rvalue reference in comparison to a case of not using the rvalue reference.

For example, the same operations are repeatedly carried out a great number of times in an application program in the field of high performance computing (HPC). Consequently, the frequency for securing memory regions and for releasing memory regions is reduced and the execution speed is further improved through the use of rvalue references.

Therefore, operations that use rvalue references are preferably carried out. However as illustrated in the example in FIG. 6, a function that declares the rvalue reference is added to the source code when writing a source code that carries out an operation that uses an rvalue reference. Specifically, the portion (2) is added.

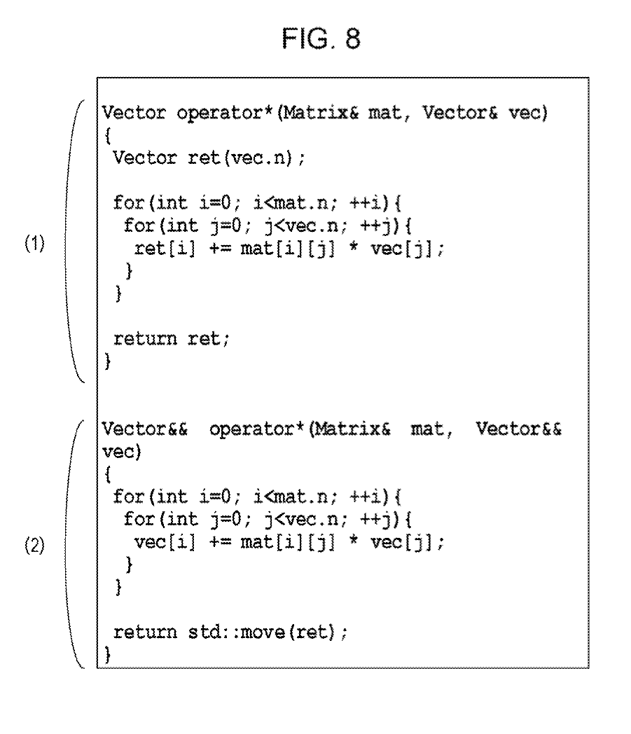

FIG. 7 illustrates an example of a function that declares an rvalue reference written in the source code when an rvalue reference is used. In the “Matrix operator+” in the source code of the example in FIG. 7, the rvalue reference is declared and two parameters “a” and “b” are defined.

In this case, three types of “operator+” are written in the source code: an “operator+” that declares the variable “a” as an rvalue reference, an “operator+” that declares the variable “b” as an rvalue reference, and an “operator+” that declares the variables “a” and “b” as rvalue references.

Therefore, when the rvalue reference is used, “operator” is written four ways for one “operator” in the source code. As a result, the coding becomes complicated. Moreover, when coding that uses a source code created by a third party is carried out, it is difficult to correctly write the four types of “operator” in the source code.

While only a summation operation of a two-dimensional array is depicted in the above example, there may be subtraction, multiplication or division operations, for example, and thus four types of “operator” are defined in the source code for each of the basic arithmetic operations which causes the coding to become even more complicated.

Further, when an addition result is assigned to a variable for addition as in “a=a+b”, for example, the writing of the assignment operator is different. In this case, the assignment operator is written as “Matrix operator+=”. Therefore, four types of functions are defined in the source code in this case as well.

### Example of Automatic Creation of Function that Declares rvalue Reference

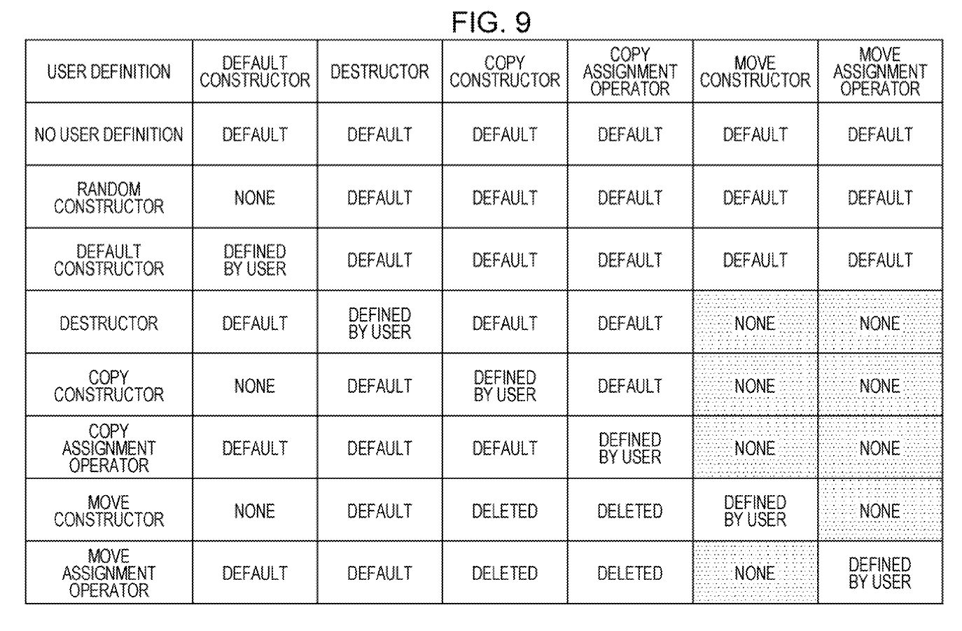

FIG. 8 illustrates an example of a sample code of the function “operator+” for carrying out a sum-of-product operation among two-dimensional arrays. The portion (1) in FIG. 8 is the coded portion (written portion). The portion (2) is an example of a function in which the rvalue reference is defined based on the portion (1).

The written content of the coded “operator+” for carrying out the sum-of-product operation in portion (1) is similar to the written content of the coded “operator+” that declares the rvalue reference in portion (2). Therefore, the compilation apparatus 1 is able to automatically create the portion (2) by converting a portion of the coded portion (1).

However, depending on the rules of the object-oriented language used in the source code, the compilation apparatus 1 may not create the “operator+” that declares the rvalue reference. When the following five definitions are set in one class of the source code, the compilation apparatus 1 does not create the “operator+” that declares the rvalue reference: 1) when a destructor is defined; 2) when a copy constructor is defined; 3) when a copy assignment operator is defined; 4) when a move constructor is defined; 5) when a move assignment operator is defined.

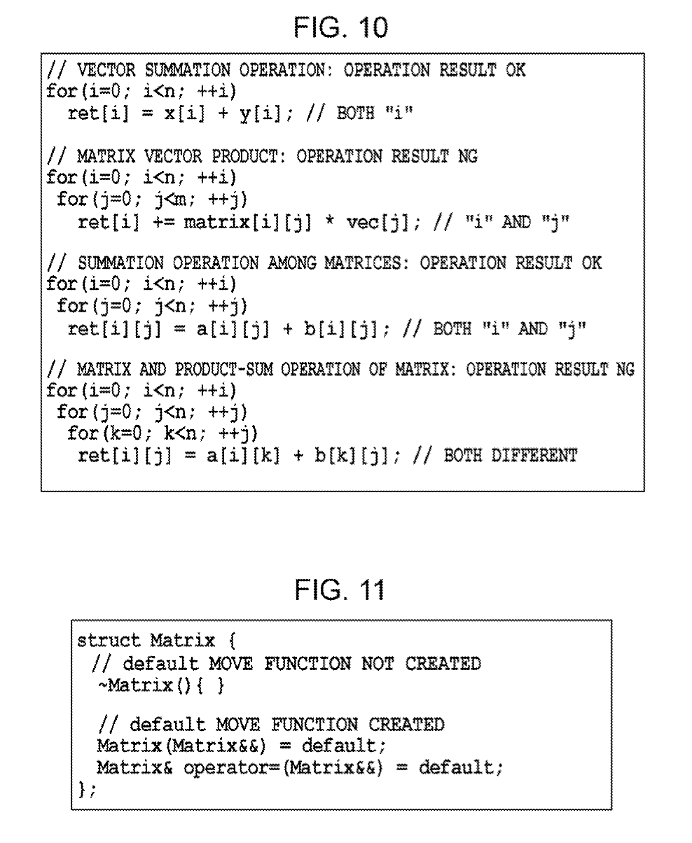

The shaded fields with “none” in the example in FIG. 9 represent the above five cases. The term “default” represents a case (implied declaration) when the compilation apparatus 1 automatically creates a special member function based on the coded portion. This function is called a “defaulted function”.

There are six types of special member functions in the present embodiment: the constructor, the destructor, the copy constructor, the copy assignment operator, the move constructor, and the move assignment operator.

The fields including “defined by user” in the example in FIG. 9 indicate a coded function in the source code. The fields including “deleted” indicate deleted functions.

For example, when a destructor is defined in one class in the source code, the compilation apparatus 1 does not automatically create the move constructor or the move assignment operator. This is based on the aforementioned rules of the language.

Moreover, there is a case in which an error may occur in the operation results due to the dependency relationship of the arithmetic order of the operation formula indicated by the assignment operator. The operation formula in the example in FIG. 8 indicates an array of summation operations. In this case, an error occurs in the operation result depending on whether there is a dependency relationship in the operation order between the index of the array that is the return value of the operation formula of the array and the index of each parameter in the array.

For example, the rewriting section 4A converts a portion of the “Vector operator*(Matrix& mat, Vector& vec)” portion in FIG. 8 and creates a function that declares the rvalue reference. In this case, the above portion is converted to “Vector&& operator*(Matrix& mat, Vector&& vec)”. Here, “&&” indicates that the rvalue reference is declared.

The compilation apparatus 1 creates the operation formula of the portion (2) based on the operation formula of the portion (1) in FIG. 8. In this case, if the index of the return value of the operation formula and the index of each parameter do not match, an error occurs in the operation result. Operations other than summation operation are the same.

When all the indexes of the variables of the conversion target and the indexes of the variables of the source of conversion are the same in the present embodiment, it is assumed that there is no dependency relationship in the calculation order. Conversely, if even a portion of the indexes of the variables of the conversion target and the indexes of the variables of the source of conversion are different, it is assumed that there is a dependency relationship in the calculation order.

If all of the indexes of the return values (value of conversion target) of the operation formula and the indexes of each parameter (value of source of conversion) match, no error occurs in the operation result even if the above conversion is carried out because there is no dependency relationship in the calculation order.

Conversely, even if one of the indexes of the return values of the operation formula and the indexes of each parameter is different, an error occurs in the operation result when the above conversion is carried out because there is a dependency relationship in the calculation order.

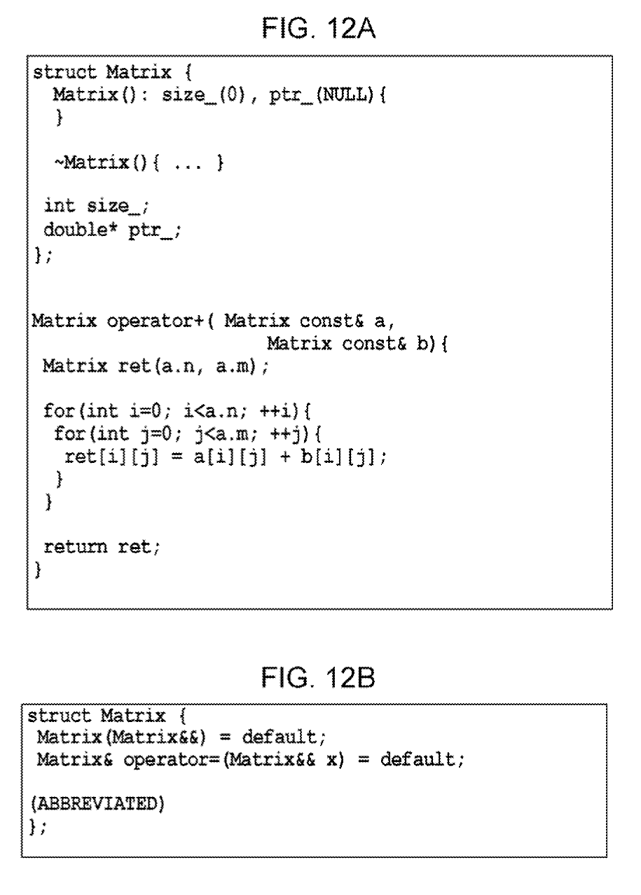

FIG. 10 illustrates an example of operation formulas in which there is a dependency relationship in the calculation order and operation formulas in which there is no dependency relationship in the calculation order. In the example of “vector summation operation” in the example in FIG. 10, all of the indexes of the return value of the operation formula and the value of each parameter are “i” and therefore match.

As a result, there is no dependency relationship in the calculation order in the operation formula and no error occurs in the operation results even if a simple conversion is carried out. In this case, the compilation apparatus 1 may create a simply converted function.

In the example of the “matrix vector product”, the index of the return value of the operation formula is “i”, but the indexes of one “matrix” among the parameters are “i” and “j”. Consequently, the indexes of the return value and the parameters are different in this case.

Therefore, an error occurs in the operation result when there is a dependency relationship in the calculation order in the operation formula and a simple conversion is carried out. In this case, the compilation apparatus 1 does not create a simply converted function.

In the example of the “summation operation among matrices”, the indexes of the return values of the operation formula are “i” and “j” and the indexes of each parameter are also “i” and “j”. Consequently, all of the indexes match and therefore there is no dependency relationship in the calculation order. In this case, no error occurs in the operation result even though a simple conversion is carried out and the compilation apparatus 1 may create a simply converted function.

In the example of the “matrix and sum-of-product operation of matrix”, the indexes of the return values of the operation formula are “i” and “j” and the indexes of each parameter are “i” and “k” and “k” and “j”. The indexes of the return values and the parameters are different.

Consequently in this example, an error occurs in the operation result when a simple conversion is carried out because there is a dependency relationship in the calculation order. Therefore, the compilation apparatus 1 does not create a simply converted function.

### Example of Automatic Creation of Move Function

In the present embodiment, when the creation of a function that declares an rvalue reference is restricted due to the rules of the above language, a “default” move constructor or move assignment operator is created.

The meaning analysis section 4 carries out a meaning analysis of the syntax tree based on the syntax tree analyzed by the syntactic analysis section 3 as discussed above. Accordingly in the present embodiment, the rewriting section 4A rewrites the data of the syntax tree so that a “default” move constructor or move assignment operator is created when the above restriction is present.

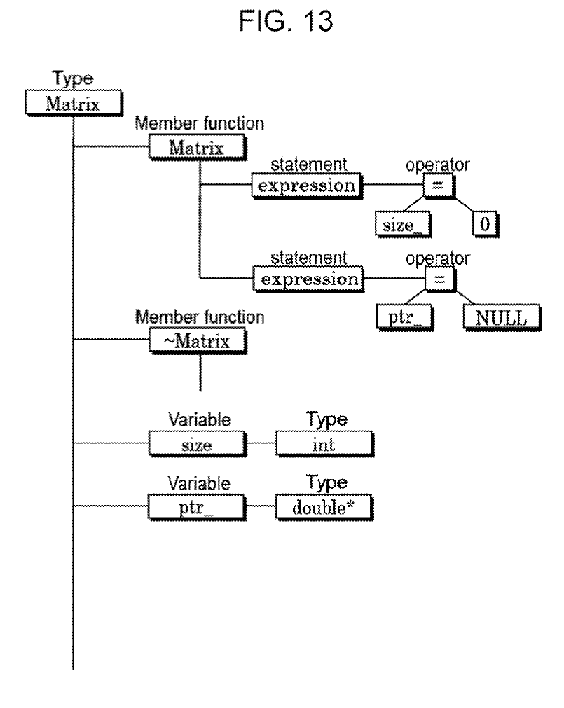

A “˜Matrix( ) { }” is defined in the example of the source code in FIG. 11. Here, “˜” indicates that a destructor is declared. Therefore, the compilation apparatus 1 does not create a “default” move constructor or move assignment operator based on the abovementioned rules.

In this case, the rewriting section 4A adds a syntax tree indicating the “default” move constructor or move assignment operator to the data of the syntax tree and rewrites the data of the syntax tree. As a result, a “default” move constructor or move assignment operator is created.

### Example of Move Automatic Creation Processing

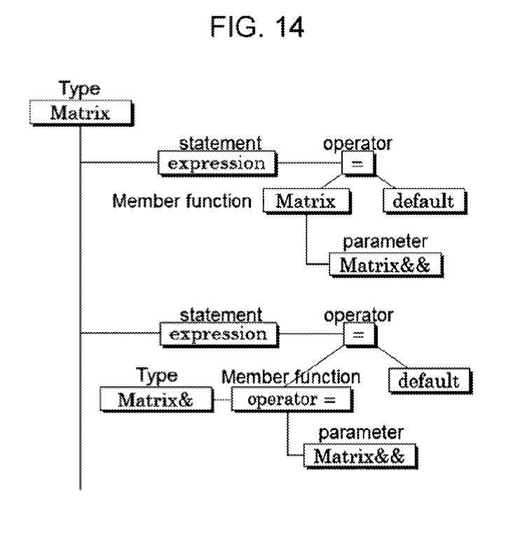

FIG. 12A and FIG. 12B are examples of two sample codes (sample code example 1 and sample code example 2). The sample code example 1 among the examples is subject to processing by the rewriting section 4A. The sample code example 2 is an example of a source code in which the “default” move constructor and move assignment operator are defined.

A class “struct Matrix” and a routine “Matrix operator+” are written in the sample code example 1 in FIG. 12A. The lexical analysis section 2 of the compilation apparatus 1 carries out a lexical analysis of the source code indicated in the sample code example 1.

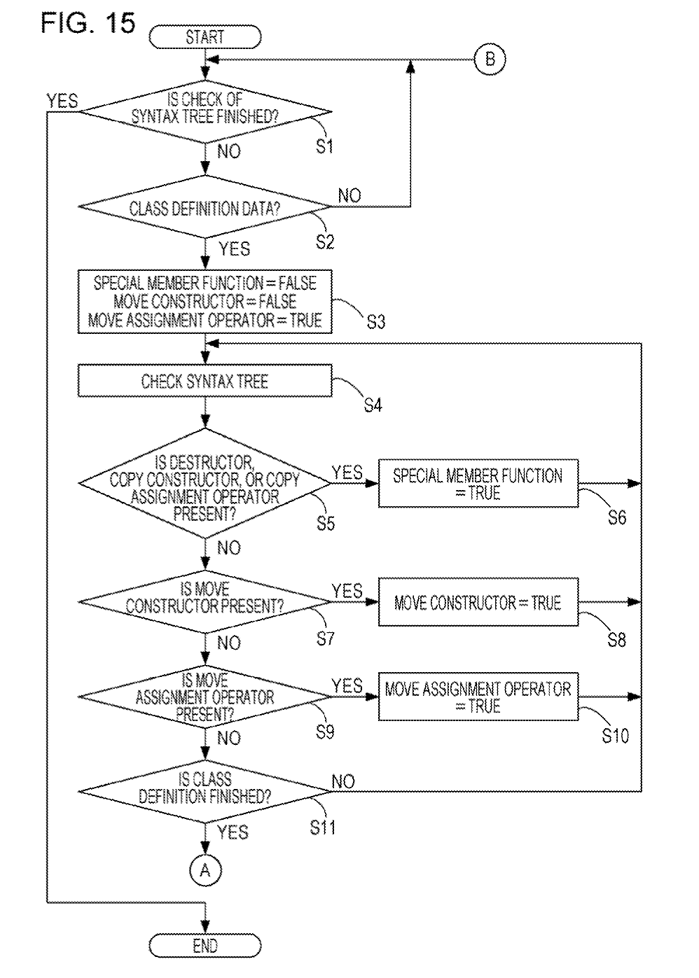

The syntactic analysis section 3 then carries out a meaning analysis based on the result of the lexical analysis and creates the syntax tree data. FIG. 13 represents the data of the syntax tree of the class “struct Matrix” in the sample code example 1.

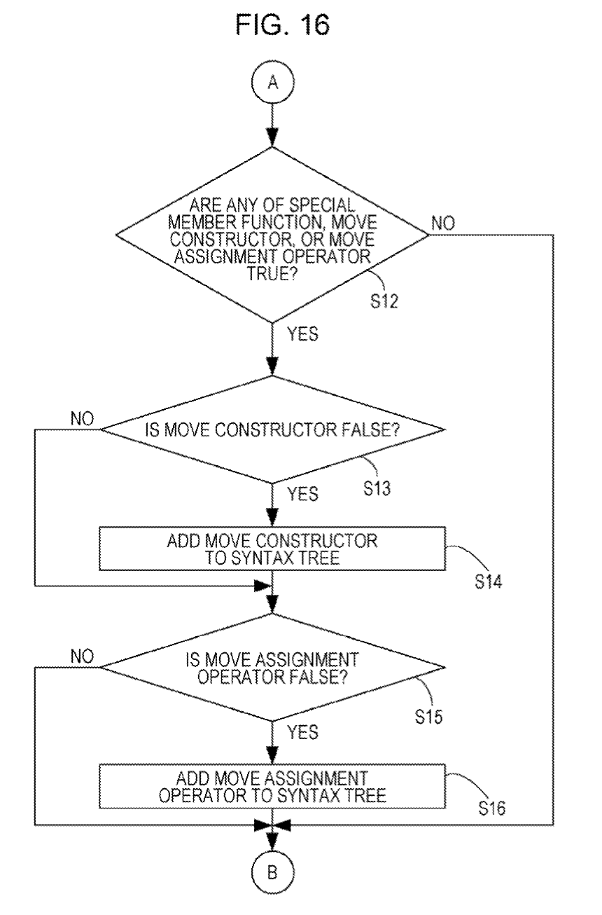

“˜Matrix” which indicates a destructor is included in the “Member function” in the data of the syntax tree. Therefore, the compilation apparatus 1 does not create a “default” move function based on the aforementioned rules. FIG. 14 is an example of the data of the syntax tree of the sample code example 2 (a source code in which the “default” move constructor and move assignment operator are defined).

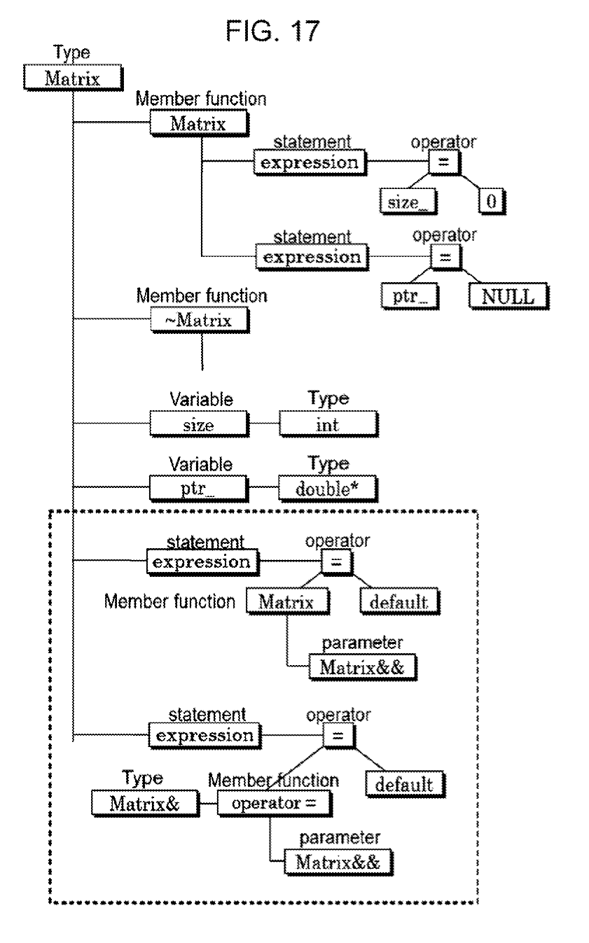

Next, an example of a processing flow of the rewriting section 4A will be explained with reference to the flow chart in FIG. 15. The rewriting section 4A determines whether a check of the data of the syntax tree is finished (step S1). If the check is finished (step S1: Yes), the processing is finished.

If the check is not finished (step S1: No), the rewriting section 4A analyzes the sample code example 1 in order and determines whether there is any data that defines a class among the data of the syntax tree (step S2).

The rewriting section 4A carries out the determination in step S2 based on the first “Type” in the data of the syntax tree. If the determination in step S2 is “No”, the processing returns to step S1.

If the determination in step S2 is “Yes”, the rewriting section 4A sets the values of the special member function, the move constructor, and the move assignment operator to “FALSE” (step S3). The values indicate whether the special member function, the move constructor, and the move assignment operator are each included in the defined class.

The rewriting section 4A checks the data of the syntax tree in the class (step S4). The rewriting section 4A determines whether a destructor, a copy constructor, or a copy assignment operator are detected in the class (step S5).

If the determination in step S5 is “Yes”, any of a destructor, a copy constructor, or a copy assignment operator is detected from the class. Alternatively, the destructor, the copy constructor, and/or the copy assignment operator may be detected from the class. In this case, the rewriting section 4A sets the value of the special member function to “TRUE” (step S6). The processing then returns to step S4.

If the determination in step S5 is “No”, the rewriting section 4A determines whether a move constructor is present in the class (step S7). If the determination in step S7 is “Yes”, the rewriting section 4A sets the value of the move constructor to “TRUE” (step S8). The processing then returns to step S4.

If the determination in step S7 is “No”, the rewriting section 4A determines whether a move assignment operator is present in the class (step S9). If the determination in step S8 is “Yes”, the rewriting section 4A sets the value of the move assignment operator to “TRUE” (step S10). The processing then returns to step S4.

The rewriting section 4A determines whether the definition of the class is finished (step S11). If the determination in step S11 is “No”, the processing returns to step S4. If the determination in step S11 is “Yes”, the processing advances to “A”.

Processing carried out by the rewriting section 4A will be explained based on the data of the syntax tree exemplified in FIG. 13. The first “Type” in the data of the syntax tree indicates “Matrix”. Specifically, the data of the syntax tree indicates that the “Matrix” type of class is defined. Therefore, the determination in step S2 becomes “Yes”.

In step S4, the rewriting section 4A checks the “Member function” and the “Variable” in the data of the syntax tree. The first “Member function” indicates a constructor. Therefore, the determinations carried out in step S5, step S7 and step S9 are all “No”.

The “Variable” of “ptr_” indicates that the definition of the classes is finished among the classes indicated in the data of the syntax tree. As a result, the determination of the step S11 is “No” at the point in time that the rewriting section 4A checks that the “Member function” is “Matrix”.

Next, the rewriting section 4A determines whether the determination of “˜Matrix” among the data of the syntax tree becomes “Yes” in steps S5, S7 and S9. The determination in step S5 is “Yes” because “˜Matrix” declares a destructor. Consequently, the value of the special member function is changed to “TRUE”.

Next, the rewriting section 4A determines whether the determination of “size” among the data of the syntax tree becomes “Yes” in steps S5, S7 and S9. Because “size” indicates a variable, the determinations carried out in step S5, step S7 and step S9 are all “No”.

Next, the rewriting section 4A determines whether the determination of “ptr_” among the data of the syntax tree becomes “Yes” in steps S5, S7 and S9. Because “ptr_” indicates a variable, the determinations carried out in step S5, step S7 and step S9 are all “No”.

Because the definition of the classes finishes at “ptr_”, the determination of step S11 is “Yes”. Therefore, the value of the special member function is changed to “TRUE” as explained above, and the values of the move constructor and the move assignment operator are not changed from “FALSE”.

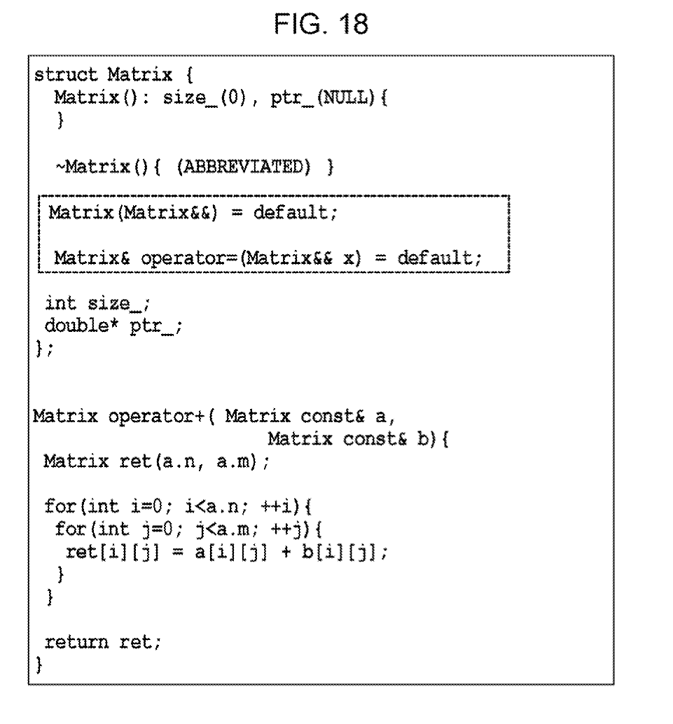

Next, the processing after “A” will be explained with reference to FIG. 16. The rewriting section 4A determines whether any of the values of the special member function, the move constructor, and the move assignment operator is “TRUE” (step S12).

If the determination in step S12 is “Yes”, the rewriting section 4A determines whether the value of the move constructor is “FALSE” (step S13).

If the determination in step S13 is “Yes”, the rewriting section 4A adds a syntax tree indicating the definition of the “default” move constructor to the data of the syntax tree (step S14). If the determination in step S13 is “No”, the processing in step S14 is not carried out.

The rewriting section 4A determines whether the value of the move assignment operator is “FALSE” (step S15). If the determination in step S15 is “Yes”, the rewriting section 4A adds a syntax tree indicating the definition of a “default” move assignment operator to the data of the syntax tree (step S16). If the determination in step S15 is “No”, the processing in step S16 is not carried out.

The value of the special member function is “TRUE” and the values of the move constructor and the move assignment operator are “FASLE” with the case of the data of the syntax tree in FIG. 13. Therefore, the determination in step S12 becomes “Yes”.

Because the value of the move constructor is “FALSE”, the processing in step S14 is carried out. Because the value of the move assignment operator is “FALSE”, the processing in step S16 is carried out.

When the value of the move constructor is “FALSE”, the definition of the move constructor is not written in the class. In this case, the rewriting section 4A adds the definition of the “default” move constructor to the data of the syntax tree and rewrites the data of the syntax tree so that the move constructor is defined in the class.

Conversely, if the value of the move constructor is “TRUE”, the definition of the move constructor is written in the class. In this case, the rewriting section 4A does not add the definition of the “default” move constructor to the data of the syntax tree.

As illustrated in FIG. 16, the processing of the move assignment operator is the same as the processing of the move constructor. The processing moves from “B” and returns to step S1 in FIG. 15 if the determination in step S12 is “No”, or after the processing in step S16 is carried out.

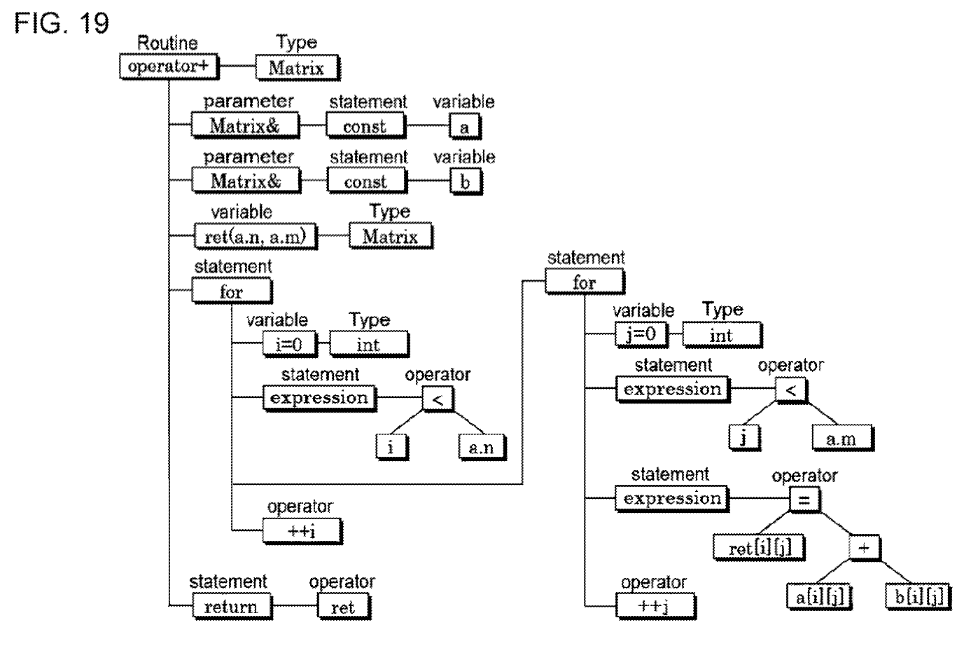

FIG. 17 illustrates an example of data of a syntax tree after the rewriting section 4A has rewritten the data of the syntax tree in FIG. 13. The move constructor and the move assignment operator are added to the data of the syntax tree in FIG. 17.

The portion enclosed in the dotted line in the data of the syntax tree in FIG. 17 indicates the syntax tree added to the data of the syntax tree by the rewriting section 4A (the syntax tree that indicates the “default” move constructor and the syntax tree that indicates the “default” move assignment operator). The added syntax tree is the same as the syntax tree illustrated in FIG. 14.

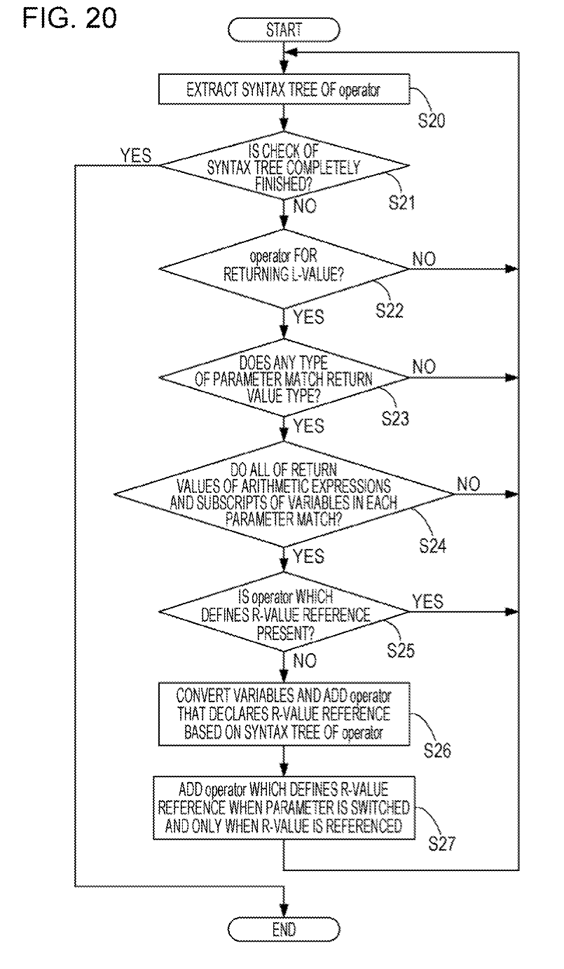

FIG. 18 illustrates a sample code example 1 based on the data of the syntax tree rewritten by the rewriting section 4A. The source code recovery section 8 in the present embodiment recovers the sample code example 1 based on the data of the rewritten syntax tree.

The portion enclosed in the dotted line in the sample code example 1 indicates the move constructor and the move assignment operator added by the rewriting section 4A.

### Example of “Operator” Automatic Creation Processing

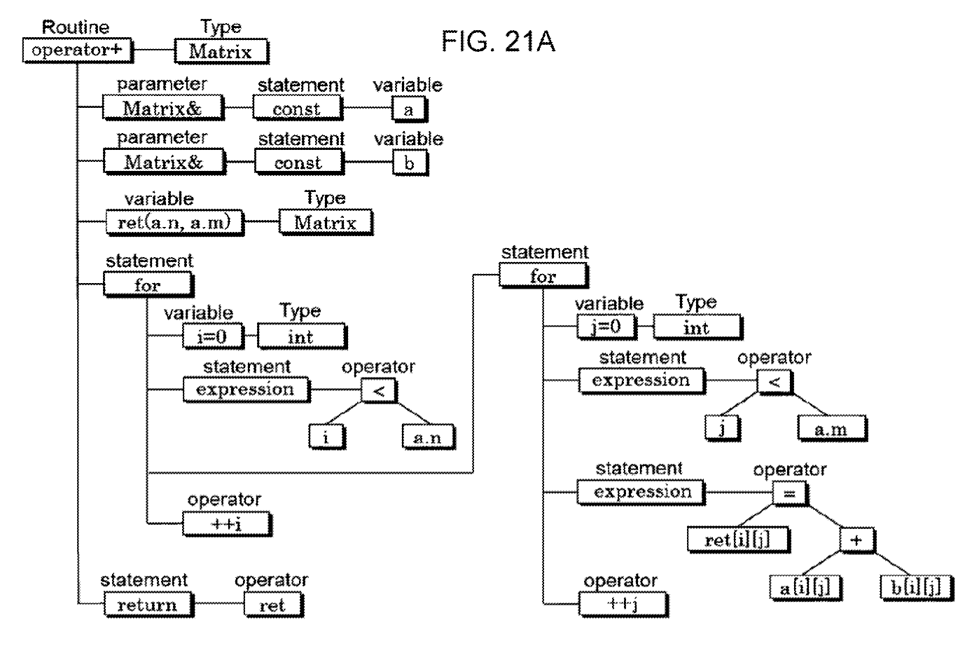

FIG. 19 illustrates a syntax tree of an “operator+” within the sample code example 1. The rewriting section 4A rewrites the data of the syntax tree to data of a syntax tree that uses an rvalue reference based on the syntax tree of the “operator+”.

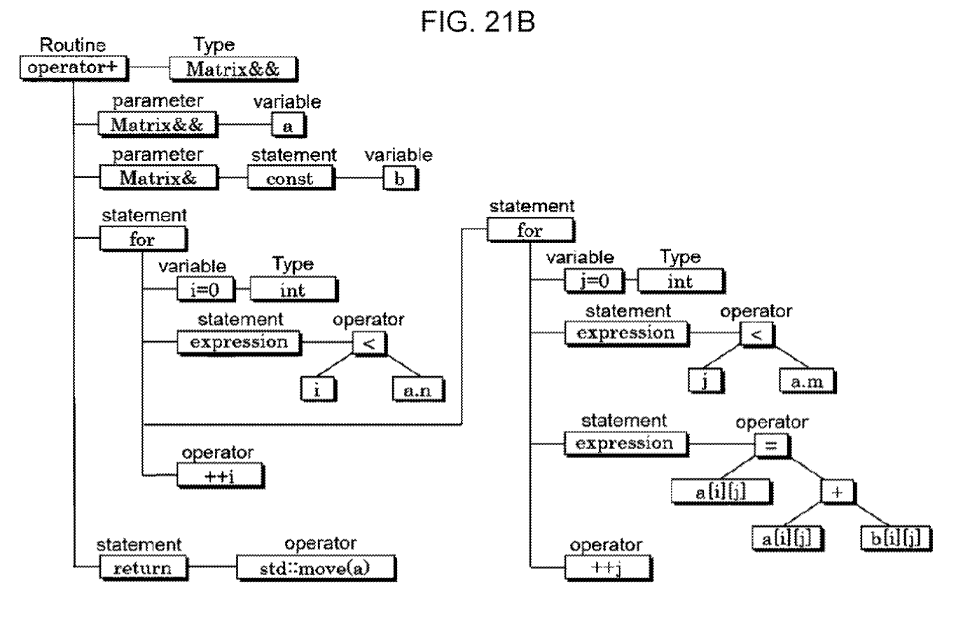

FIG. 20 is a flow chart of an example of the processing flow of the rewriting section 4A. The rewriting section 4A extracts the syntax tree of the “operator” from the data of the syntax tree (step S20).

The rewriting section 4A determines whether all the checking of the data of the syntax tree is finished (step S21). If the determination in step S21 is “Yes”, the processing is finished. If the determination in step S21 is “No”, a determination is made as to whether the syntax tree of the “operator” is an “operator” that returns an L-value (step S22).

If the determination in step S22 is “No”, the syntax tree of the “operator” is not an “operator” that returns an L-value. In this case, the rewriting section 4A does not rewrite the data of the syntax tree. The processing then returns to step S20.

If the determination in step S22 is “Yes”, the rewriting section 4A determines whether any type of the parameter of the “operator” matches the type of the return value (step S23). If the determination in step S23 in “No”, none of the types of the parameters of the “operator” match the type of the return value.

In this case, because there is no operator having a type that matches a return value, the processing involving the rewriting section 4A rewriting the syntax tree to the data of a syntax tree that uses an rvalue reference is complicated. Therefore, if the determination in step S23 is “No”, the processing returns to step S20.

The rewriting section 4A searches the syntax tree of the “operator” and determines whether the indexes of the variables of the return values of the operation formula are all the same as the indexes of the variable for each parameter (step S24). If the determination in step S24 is “No”, a dependency relationship of the calculation order is present.

As a result, when the data of the syntax tree is rewritten to the data of a syntax tree that uses an rvalue reference based on the syntax tree of the “operator+”, an error occurs in the operation result of the operation formula based on the rewritten syntax tree.

Consequently, if the determination in step S24 is “No”, the rewriting section 4A does not rewrite the data of the syntax tree to the data of a syntax tree that uses an rvalue reference. As a result, the processing returns to step S20.

Conversely, if the determination in step S24 is “Yes”, all of the indexes of the variables of the return values of the operation formula and the indexes of the variable in each parameter match. In this case, even if the data of the syntax tree is rewritten to the data of the syntax tree that uses the abovementioned rvalue reference based on the syntax tree of the “operator+”, no error occurs in the operation result of the operation formula prescribed with “operator+”.

In this case, the rewriting section 4A searches the data of the syntax tree and determines whether there is a syntax tree of an “operator” that declares an rvalue reference (step S25).

If the determination in step S25 is “Yes”, the abovementioned rewriting to the data of the syntax tree that uses the rvalue reference is not carried out because the syntax tree of the “operator” that declares the rvalue reference present in the data of the syntax tree may be used. As a result, the processing returns to step S20.

If the determination in step S25 is “No”, the rewriting section 4A converts the variables based on the syntax tree of the “operator”, adds the syntax tree indicating the “operator” that uses the rvalue reference to the data of the syntax tree, and rewrites the data of the syntax tree (step S26).

Further, the rewriting section 4A adds the syntax tree that indicates the “operator” when the two parameters of the added “operator” are switched, and the syntax tree of the “operator” which defines the rvalue reference in both of the two parameters, to the data of the syntax tree. As a result, the data of the syntax tree is rewritten (step S27).

In the case of the example of the syntax tree in FIG. 19, the rvalue of the “operator+” is a “Matrix” type and the return value “ret” is also a “Matrix” type. Therefore, the determination in step S22 becomes “Yes”.

The syntax tree of the “operator+” indicates that the return value is a “Matrix” type and the variables of both parameters “a” and “b” are “Matrix” types. Therefore, the determination in step S23 becomes “Yes”.

The syntax tree of the “operator+” indicates that indexes of all the variables of the array “ret”, “a” and “b” are “i” and “j”. Therefore, the determination in step S24 becomes “Yes”.

The “operator” that declares the rvalue reference is not defined in the data of the syntax tree. Therefore, the determination in step S25 becomes “No”. Therefore, the processing in steps S26 and S27 is carried out.

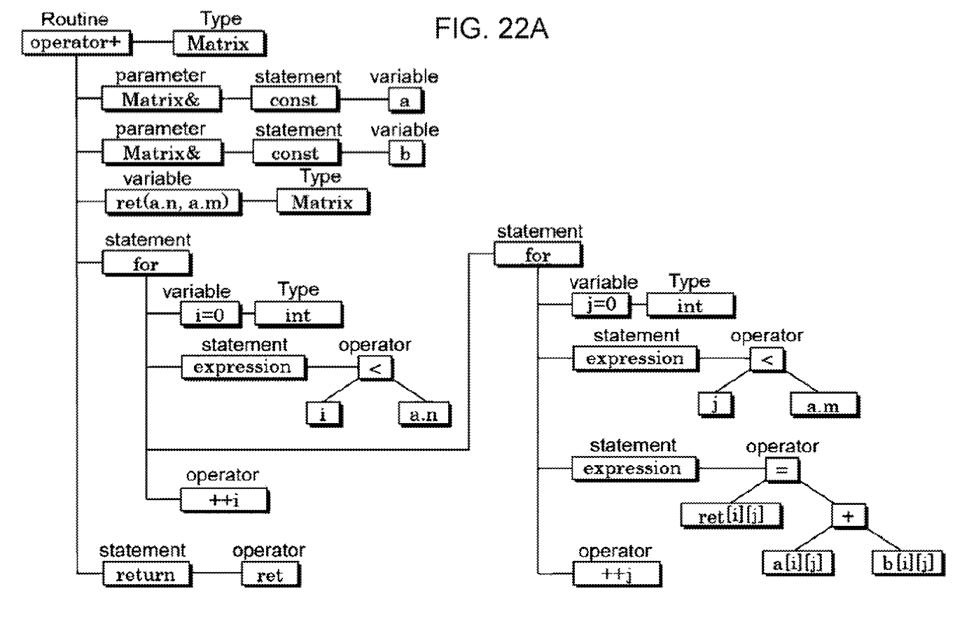

FIG. 21A and FIG. 21B illustrate an example of a syntax tree of the “operator+” illustrated in FIG. 19 and an example of the added syntax tree in the processing in step S26. The rewriting section 4A converts a portion of the syntax tree of the “operator+” and creates the syntax tree added in the processing in step S26.

In the example in FIG. 21B, the rewriting section 4A converts the “Type” corresponding to the “operator+” to “Matrix&&”. Moreover, the rewriting section 4A converts the “Matrix&” to which corresponds the variable “a” of “parameter” to “Matrix&&”. As a result, the variable “a” of the “operator+” declares the use of the rvalue reference.

Further, the rewriting section 4A converts the “operator” of “statement” to “std::move(a)”. As a result, the move is realized by the move assignment operator. The rewriting section 4A creates the syntax tree added in the processing in step S26 by carrying out the above converting.

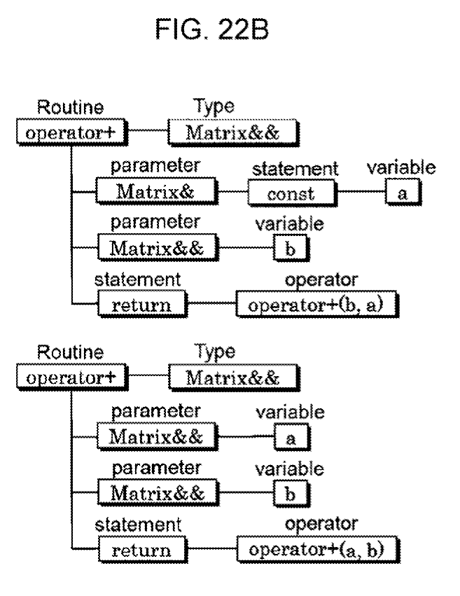

FIG. 22A and FIG. 22B illustrate an example of a syntax tree of the “operator+” illustrated in FIG. 19 and an example of the added syntax tree in the processing in step S27. The rewriting section 4A converts a portion of the syntax tree of the “operator+” and creates the syntax tree added in the processing in step S27.

The rewriting section 4A converts the “Type” corresponding to the “operator+” to “Matrix&&”. Moreover, the rewriting section 4A converts the “Matrix&” to which corresponds the variable “b” of “parameter” to “Matrix&&”. As a result, the variable “b” of the “operator+” declares the use of the rvalue reference.

In the case of the example in FIG. 22B, the syntax “for” of the “statement” is deleted. The rewriting section 4A converts the “operator” corresponding to “return” in the “statement” to “operator+(b,a)”. According to the above processing, the parameter that declares the use of the rvalue reference among the two parameters is switched.

The other added syntax tree among the examples in FIG. 22A and FIG. 22B indicates that both “a” and “b” which are parameters of the “operator” use rvalue references. As a result, the rewriting section 4A converts the “Type” corresponding to the “operator+” to “Matrix&&”.

Moreover, the rewriting section 4A converts the “Matrix&” which corresponds to the variables “a” and “b” of “parameter” to “Matrix&&”. As a result, the variables “a” and “b” of the “operator+” declare the use of the rvalue reference.

The rewriting section 4A then converts the “operator” corresponding to “return” in the “statement” to “operator+(a,b)”. According to the above processing, the use of the rvalue reference by both of the two parameters of the “operator” is declared.

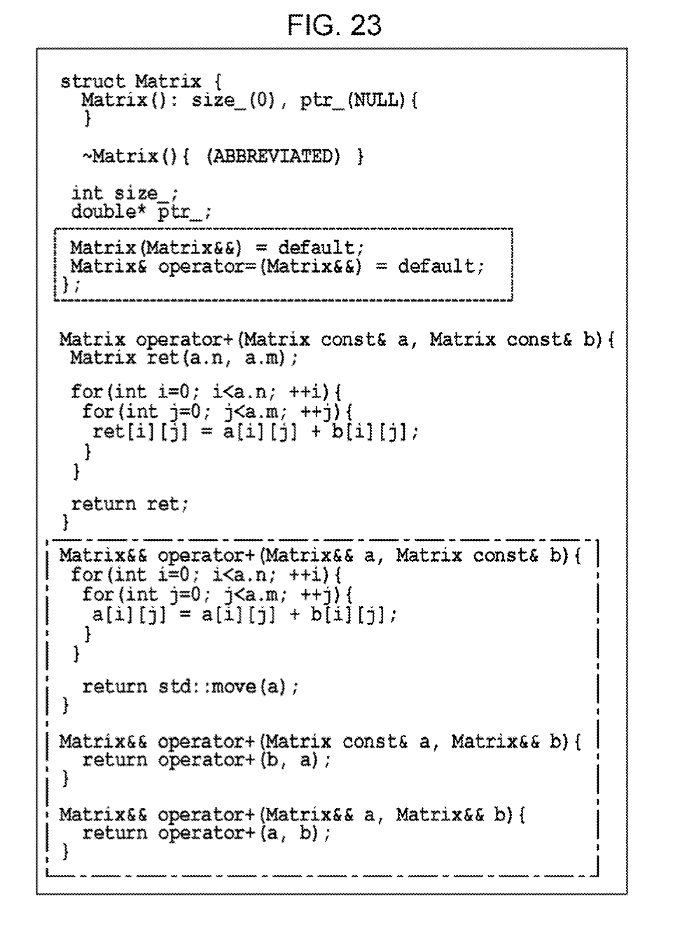

The rewriting section 4A adds the above syntax tree to the data of the syntax tree and rewrites the syntax tree. FIG. 23 illustrates an example of the source code in which the data of the syntax tree rewritten by the rewriting section 4A is recovered. The recovery of the source code is carried out by the source code recovery section 8.

The portion enclosed in the dotted line in the sample code example 1 in FIG. 23 indicates the portion added by the move automatic creation processing. The portion enclosed in the chain line indicates the portion added by the operator automatic creation processing.

The intermediate language output section 5 creates and outputs the intermediate language based on the data of the rewritten syntax tree. The optimizing section 6 optimizes the output intermediate language. The object code creating section 7 creates an object code from the optimized intermediate language.

Therefore in the present embodiment, the rewriting section 4A adds a syntax tree that indicates a function that declares an rvalue reference to the data of the syntax tree, and because the data of the syntax tree is rewritten, the quantity of times for securing and releasing a region in the memory can be restricted. As a result, the execution speed improves.

The processing for adding the abovementioned various types of syntax trees to the data of the syntax tree is carried out by the rewriting section 4A. Accordingly, a syntax tree that indicates a function that declares an rvalue reference can be automatically added to the data of the syntax tree. Therefore, the execution speed of a source code that does not use a function of the rvalue reference can be improved in a simple manner.

A “default” move function that declares an rvalue reference may not be created due to the abovementioned rules of the language. In this case, the abovementioned “default” move function is added to the data of the syntax tree due to the rewriting section 4A rewriting the data of the syntax tree. As a result, the execution speed of the object code is improved.

However, an error may occur in the operation result due to the occurrence of a dependency relationship in the calculation order when the index of the return value of an operation formula of an array and the index of each parameter do not match even if the “default” move function is added.

In the present embodiment, the rewriting section 4A carries out the operator automatic creation processing when all of the indexes of the return value of an operation formula of an array are the same as the indexes of the parameters. As a result, the occurrence of an error in the operation result caused by the dependency relationship of the calculation order can be avoided.

Moreover, the data of the syntax tree rewritten by the rewriting section 4A does not depend on the architecture executed by a compilation apparatus. Moreover, the source code recovery section 8 recovers the source code rewritten by the rewriting section 4A. Therefore, the source code can be used by another compilation apparatus.

The source code output section 10 may output the source code recovered from the data of the rewritten syntax tree, to a display, for example. For example, how the original source code was rewritten can be presented by displaying the recovered source code on the display. As a result, a measure for improving the performance of source code levels can be presented.

### Example of a Hardware Configuration of the Compilation Apparatus

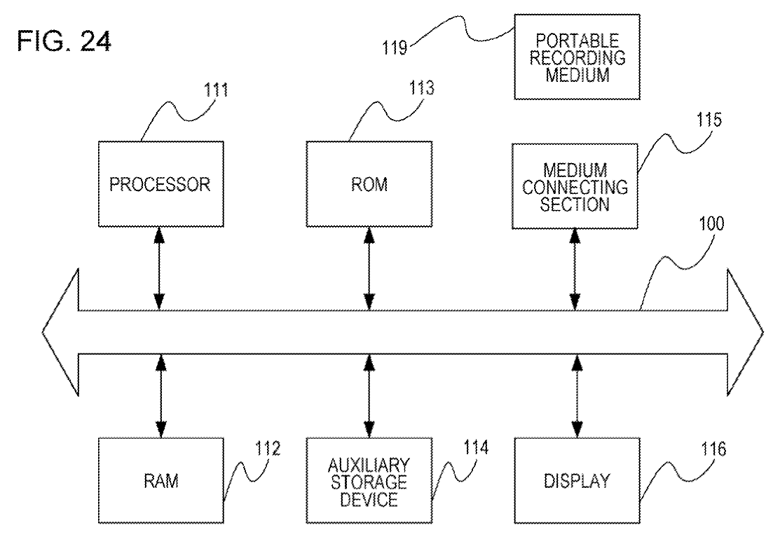

Next, an example of a hardware configuration of the compilation apparatus 1 will be explained with reference to the example of FIG. 24. As illustrated in FIG. 24, a processor 111, a RAM 112, a ROM 113, an auxiliary storage device 114, a medium connecting section 115, and a display 116 are all connected to a bus 100.

The processor 111 is a circuit for any processing and is the abovementioned CPU. The processor 111 executes programs expanded in the RAM 112. The program for carrying out the processing of the present embodiment may be used as an executed program. The ROM 113 is a non-volatile storage device for storing the programs expanded in the RAM 112.

The auxiliary storage device 114 is a storage device for storing various types of information, and a hard disc drive or a semiconductor memory and the like may be used as the auxiliary storage device 114. The medium connecting section 115 is provided to enable connection with a portable recording medium 119.

A portable memory, an optical disc (for example, a compact disc (CD), a digital versatile disc (DVD), etc.), or a semiconductor memory and the like may be used as the portable recording medium 119. The program for carrying out the processing of the present embodiment may be recorded on the portable recording medium 119.

The storage section 9 in the compilation apparatus 1 may be realized by the RAM 112 or the auxiliary storage device 114 and the like. Sections other than the storage section 9 in the compilation apparatus 1 may be realized by the processor 111 executing a given compiling program.

The RAM 112, the ROM 113, the auxiliary storage device 114, and the portable recording medium 119 are all examples of tangible computer-readable storage media. These tangible storage media are not temporary media such as a signal carrier wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A compilation apparatus comprising:
a memory; and
a processor coupled to the memory and the processor configured to:
add a syntax tree for indicating a first function that declares a reference to data of a parse tree created based on a source code when compiling the source code, the reference being a function for a right-hand-side value reference, and
rewrite the data of the parse tree when the first function that declares the reference is not detected and a specific second function different from the first function is detected from data of the parse tree.

2. The compilation apparatus according to claim 1, wherein
when the second function is written in the source code, the processor is configured to
convert a portion of the writing of the second function,
create a syntax tree that indicates the first function that declares the reference, and
add the created syntax tree to the data of the parse tree.

3. The compilation apparatus according to claim 1, wherein
the first function is a move constructor or a move assignment operator, and
the second function is a destructor, a copy constructor, and/or a copy assignment operator.

4. The compilation apparatus according to claim 3, wherein
the processor is configured to add a syntax tree that indicates the move constructor that is defaulted or the move assignment operator that is defaulted to the data of the parse tree.

5. The compilation apparatus according to claim 1, wherein
when there are a plurality of parameters of the first function, the processor is configured to add a parse tree which indicates the function that gives a declaration of the reference for each parameter and a parse tree that indicates the function that gives a declaration of the reference for all the parameters, to the data of the parse tree.

6. The compilation apparatus according to claim 3, wherein
when a parse tree that indicates any one of the move constructor and the move assignment operator is detected, and a parse tree that indicates the other thereof is not detected, the processor does not add the detected parse tree to the data of the parse tree.

7. The compilation apparatus according to claim 3, wherein
the processor is configured to add a parse tree that indicates the converted function to the data of the parse tree only when an operation formula that uses the move assignment operator is an operation formula of an array having one or more dimensions, and a return value index of the operation formula and indexes of each of a plurality of parameters are the same.

8. The compilation apparatus according to claim 1, wherein
the processor is configured to output a source code in which the data of the rewritten parse tree is recovered.

9. A compiling method for compiling a source code with a computer, the method comprising:
adding a syntax tree that indicates a first function that declares a reference to data of a parse tree created based on the source code, the reference being a function for a right-hand-side value reference, and
rewriting the data of the parse tree when the first function that declares the reference is not detected and a specific second function different from the first function is detected from the data of the parse tree.

10. A non-transitory, computer-readable recording medium having stored therein a program for causing a computer to execute a process, the process comprising:
adding a syntax tree for indicating a first function that declares a reference to data of a parse tree created based on the source code, the reference being a function for a right-hand-side value reference, and
rewriting the data of the parse tree when the first function that declares the reference is not detected and a specific second function different from the first function is detected from data of the parse tree.
